(19) United States
(12) Patent Application Publication
(10) Pub. No.: US 2020/0026743 A1
(43) Pub. Date: Jan. 23, 2020

(54) METHOD, DEVICE AND SYSTEM FOR PROVIDING SOCIAL OBJECTS

(71) Applicant: SHANGHAI ZHANGMEN SCIENCE AND TECHNOLOGY CO.,LTD., Shanghai (CN)

(72) Inventors: Danian CHEN, Shanghai (CN); Haijin FAN, Shanghai (CN)

(73) Assignee: SHANGHAI ZHANGMEN SCIENCE AND TECHNOLOGY CO.,LTD., Shanghai (CN)

(21) Appl. No.: 16/585,370

(22) Filed: Sep. 27, 2019

Related U.S. Application Data
(63) Continuation of application No. PCT/CN2017/119836, filed on Dec. 29, 2017.

(30) Foreign Application Priority Data
Mar. 31, 2017 (CN) 201710208749.9

(51) Int. Cl. G06F 16/9536; G06Q 50/00; G06F 16/903

(52) U.S. Cl. CPC G06F 16/9536; G06F 16/90344; G06Q 50/01

(57) ABSTRACT

A method, a device and a system for providing social objects. The user device generates the image information of the social object expected by the user according to the image editing operation of the user, and then sends the image information to the corresponding network device. The network device performs a match query in an object information database to obtain one or more social objects matching with the image information. Then, the network device sends at least one of the one or more social objects to the user device, and the at least one of the one or more social objects is presented to the user. Therefore, the user may quickly find the social objects matching with the image information of the social object expected by the user, improving the user experience.

### CROSS REFERENCE TO THE RELATED APPLICATIONS

This application is the continuation application of International Application No. PCT/CN2017/119836, filed on Dec. 29, 2017, which is based upon and claims priority to Chinese Patent Application No. 201710208749.9, filed on Mar. 31, 2017, the entire contents of which are incorporated herein by reference.

### TECHNICAL FIELD

The present application relates to the field of communications, and in particular to a technique for providing social objects.

### BACKGROUND

Physical appearance is usually considered as one of the most important factors in the courses of love, marriage, and dating someone. Many people are expecting their partner to have the physical appearance of their “dream lover”. However, in the prior art, it is a pity that few solutions are offered to provide the users the social objects according to the type of the physical appearance of their “dream lover”.

### SUMMARY

An objective of the present application is to provide a method, device and system for providing social objects.

In one aspect of the present application, a method for providing social objects at a user device side is provided, which includes the following steps:

generating image information of a social object expected by a user according to an image editing operation of the user;

sending the image information to a corresponding network device;

receiving one or more social objects matching with the image information sent by the network device; and

presenting at least one of the one or more social objects.

In another aspect of the present application, a method for providing social objects at a network device side is provided, which includes the following steps:

receiving image information of a social object expected by a user sent by a user device;

performing a match query in an object information database according to the image information to obtain one or more social objects matching with the image information; and

sending at least one of the one or more social objects to the user device.

In yet another aspect of the present application, a method for providing social objects is provided, which includes the following steps:

generating, by a user device, image information of a social object expected by a user according to an image editing operation of the user;

sending, by the user device, the image information to a corresponding network device;

receiving, by a network device, the image information of the social object expected by the user sent by the user device;

performing, by the network device, a match query in an object information database according to the image information to obtain one or more social objects matching with the image information;

sending, by the network device, at least one of the one or more social objects to the user device;

receiving, by the user device, one or more social objects matching with the image information sent by the network device; and

presenting, by the user device, at least one of the one or more social objects.

In yet another aspect of the present application, a computer readable medium containing instructions is provided, wherein the instructions, when being executed, cause a system to perform the following steps:

generating image information of a social object expected by a user according to an image editing operation of the user;

sending the image information to a corresponding network device;

receiving one or more social objects matching with the image information sent by the network device; and

presenting at least one of the one or more social objects.

In yet another aspect of the present application, a computer readable medium containing instructions is provided, wherein the instructions, when being executed, cause a system to perform the following steps:

receiving image information of a social object expected by a user sent by a user device;

performing a match query in an object information database according to the image information to obtain one or more social objects matching with the image information; and

sending at least one of the one or more social objects to the user device.

In yet another aspect of the present application, a user device for providing social objects is provided, which includes:

a processor; and

a memory configured to store computer executable instructions, wherein, the computer executable instructions, when being executed, cause the processor to perform the following steps:

generating image information of a social object expected by a user according to an image editing operation of the user;

sending the image information to a corresponding network device;

receiving one or more social objects matching with the image information sent by the network device; and

presenting at least one of the one or more social objects.

In yet another aspect of the present application, a network device for providing social objects is provided, which includes:

a processor; and

a memory configured to store computer executable instructions, wherein, the computer executable instructions, when being executed, cause the processor to perform the following steps:

receiving image information of a social object expected by a user sent by a user device;

performing a match query in an object information database according to the image information to obtain one or more social objects matching with the image information; and

sending at least one of the one or more social objects to the user device.

Compared with the prior art, in the present application, the user device generates the image information of the social object expected by the user according to the image editing operation of the user, and then sends the image information to the corresponding network device. The network device performs a match query in an object information database to obtain one or more social objects matching with the image information. Then, the network device sends at least one of the one or more social objects to the user device, and the at least one of the one or more social objects is presented to the user. Therefore, the user may quickly find the social objects matching with the image information of the social object expected by the user, improving the user experience. Further, the user may perform the image editing operation based on a reference image, which reduces the time of the image editing operation and improves the efficiency. Furthermore, the network device may first perform a match query according to text parameters to rule out the objects in the object information base that does not match with the text parameters, and then perform a match query according to the image parameters, thereby improving the efficiency of the match query and reducing the workload of the system.

### BRIEF DESCRIPTION OF THE DRAWINGS

Other features, objectives, and advantages of the present application are clarified with the detailed description of the non-restrictive embodiments with reference to the accompanying drawings.

FIG. 1 is a topological diagram showing a system for providing social objects according to an embodiment of the present application; and

FIG. 2 shows a flow chart of a method for providing social objects according to another embodiment of the present application.

The same or similar reference numerals in the drawings denote the same or similar components.

### DETAILED DESCRIPTION OF THE EMBODIMENTS

The present application is further described in detail below with reference to the accompanying drawings.

In a typical configuration of the present application, the end device, network service device, and trustee all include at least one central processing unit (CPU), at least one input/output interface, at least one network interface, and at least one memory.

The memory may be a computer readable medium in the form of a non-persistent memory, a random access memory (RAM), and/or a non-volatile memory etc., for example, a read only memory (ROM) or a flash random access memory (flash RAM). The memory is an example of the computer readable medium.

The computer readable medium may be a permanent media, a non-persistent media, a removable media, or a non-removable media, which can store information by any method or technique. The information may be computer readable instructions, data structures, program modules, or other data. Examples of the computer storage medium include, but are not limited to, a phase-change random access memory (PRAM), a static random access memory (SRAM), a dynamic random access memory (DRAM), other types of random access memories (RAM), a read only memory (ROM), an electrically erasable programmable read only memory (EEPROM), a flash memory or other memory techniques, a compact disk-read only memory (CD-ROM), a digital versatile disc (DVD) or other optical storages, a magnetic tape cartridge, a magnetic tape storage, other magnetic storage devices, or other non-transportable medium, which can be used to store information accessible to a computing device. As defined herein, the computer readable medium does not include non-transitory computer readable media, such as modulated data signals and carrier waves.

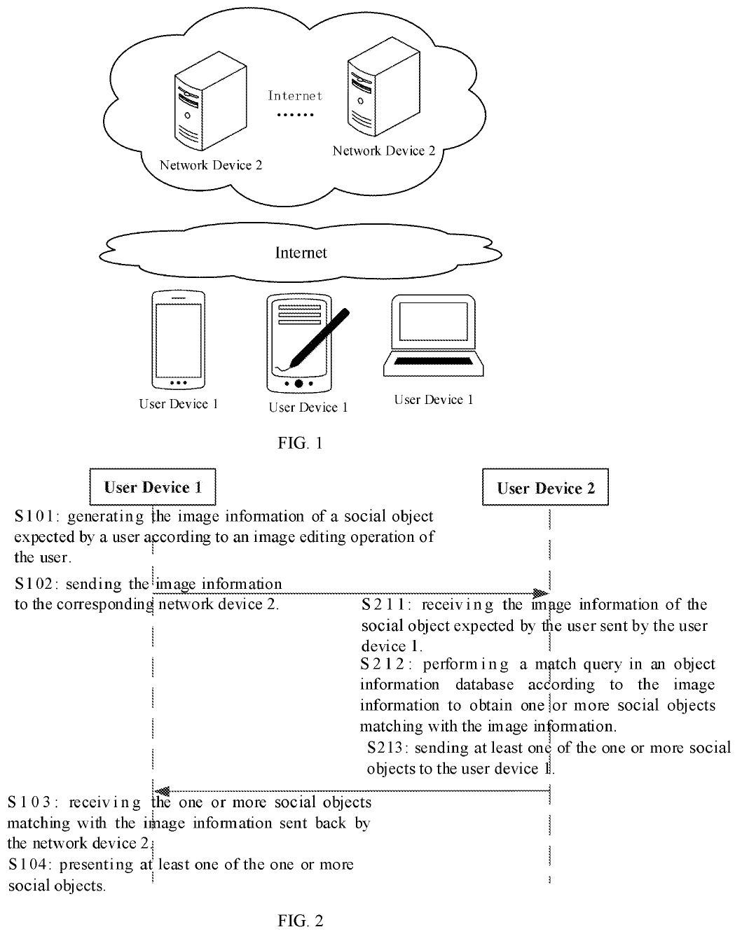

FIG. 1 is a topological diagram showing a system for providing social objects according to an embodiment of the present application, and the system includes the user device 1 and the network device 2.

The network device 2 includes an electronic device capable of automatically performing numerical calculation and information processing according to preset or prestored instructions. The hardware of the electronic device includes, but is not limited to, a microprocessor, an application specific integrated circuit (ASIC), a field-programmable gate array (FPGA), a digital processor (DSP), and an embedded devics, etc. The network device 2 includes, but is not limited to, a computer, a network host, a single network server, a group of multiple network servers, or a cloud composed of multiple servers. The cloud is composed of a large number of computers or network servers based on cloud computing, and the cloud computing is a type of distributed computing which is based on a virtual supercomputer consisting of a cluster of loosely connected computers. The network includes, but is not limited to, the Internet, a wide area network, a metropolitan area network, a local area network, a virtual private network (VPN), a wireless ad hoc network, etc. The user device 1 includes, but is not limited to, a mobile electronic product that can perform human-computer interaction with the user, such as a smart phone, a tablet computer, a laptop, etc. The mobile electronic product may use any operating system, such as the Android operating system, the iOS operating system, and the Windows operating system, etc.

For the sake of brevity, a system composed of the network device 2 and one user device 1 is taken as an example in the following description.

FIG. 2 shows a flow chart of a method for providing social objects according to another embodiment of the present application. Specifically, the method includes step S101, step S102, step S103 and step S104 performed at the user device side, and step S211, step S212 and step S213 performed at the network device side.

Specifically, in the step S101, the user device 1 generates image information of a social object expected by a user according to an image editing operation of the user; in the step S102, the user device 1 sends the image information to a corresponding network device 2; in the step S211, the network device 2 receives the image information of the social object expected by the user sent by the user device 1; in the step S212, the network device 2 performs a match query in an object information database according to the image information to obtain one or more social objects matching with the image information; in the step S213, the network device 2 sends at least one of the one or more social objects to the user device 1; in the step S103, the user device 1 receives the one or more social objects matching with the image information sent by the network device 2; and in the step S104, the user device 1 presents at least one of the one or more social objects.

For example, the user uses a specific application (including, but not limited to, a web application, an application installed on the user device, etc.) on the user device 1 to obtain the image information of the expected social object (such as “dream lover”) by the image editing operation. Then, the user device 1 sends the image information of the social object expected by the user to the network device 2 at the cloud side of the specific application. The network device 2 performs the match and query in the object information database storing a huge amount of user image information (the facial matching techniques used include, but are not limited to, geometric matching based on eye coordinates, matching based on scale-invariant feature transform (SIFT), and template matching based on statistical features, etc.) to obtain one or more social objects matching with the image information of the social object expected by the user.

After that, the network device 2 sends the one or more social objects to the user device 1. Alternatively, the network device 2, according to the level of the matching degree, sends one social object having the highest matching degree or a plurality of social objects having relatively higher matching degrees in the one or more social objects to the user device 1.

After the user device 1 receives the one or more social objects matching with the image information of the social object expected by the user, the one or more social objects are presented to the user through the specific application (the presented information includes but is not limited to the following aspects: image information, height, age, occupation, etc. of the social object). Alternatively, according to the level of the matching degree, one social object having the highest matching degree or a plurality of social objects having relatively higher matching degrees in the one or more social objects are presented to the user.

Obviously, those skilled in the art should be able to understand that the above facial matching techniques, such as geometric matching based on eye coordinates, matching based on scale-invariant feature transform (SIFT), and template matching based on statistical features, etc., are taken as examples only, and if other face matching techniques that are currently available or may be developed in the future are applicable to the present application, these face matching techniques are also included in the scope of the present application and are hereby incorporated by reference.

In a specific embodiment, the image information of the social object expected by the user and image information in the object information database may be matched by the following steps.

1) The Face in the Image Information is Positioned by Using an Image Face Detection and a Facial Feature Point Positioning.

For example, an Haar classifier and an AdaBoost algorithm may be employed to extract the Haar-like feature from the image, and the AdaBoost algorithm is used for face detection. Alternatively, the method of template matching may be employed to model by using sub-templates of eyes, nose, mouth, and face contour, etc. Then, the frontal face in the image is detected, and the correlation between the sub-images and the contour template is calculated to detect a candidate region of the face. After that, matching of other sub-templates in the candidate region is completed. Alternatively, other techniques that are currently available or may be developed in the future may be employed.

2) Geometrical Normalization of the Facial Image

A normalized facial region image (all images are identical in pixel and size) is obtained from the image according to the positions of the facial feature points. This step mainly aims to make the pixels on different faces correspond to consistent facial position, so as to offer comparability. This step may be regarded as an affine transform process of the image (completed by performing linear interpolation or image scaling).

3-1) Illumination Normalization of the Facial Image

This step mainly aims to overcome the effect of different illumination conditions on the facial image and improve the robustness of the algorithm to the illumination conditions. For example, Gaussian differential filtering (an illumination normalization method of images based on Gaussian differential filter) may be employed, or other techniques that are currently available or may be developed in the future may be employed.

3-2) Local Illumination Normalization of the Face

The pixels of the image are segmented to allow the object surface points corresponding to the pixels in each segment to have surface normal vector distribution similar to other segments, so the images would have similar gray-scale responses to the light source. Then, the local normalization is performed in each segment to impair the effects of illumination. For example, the Lambert's reflectance model of the object can be first established, and the average surface normal vector distribution matrix of the facial shape is estimated by a singular value decomposition method. The pixels are segmented according to the normal vector direction by using a clustering algorithm, and then each segment is processed by local pixel normalization.

4) Facial Image Feature Extraction

Skin color features (selected according to different color spaces of the color images, and the color spaces include RGB, SHI, YUV, etc.): the common skin color models include Gaussian model, histogram model, etc. Grayscale features: including the facial contour feature, facial grayscale distribution feature, organic feature, and template feature. The organs on the facial region (such as eyes, nose, mouth, etc.) are key features of the face. For example, the eyes, nose, mouth, and overall feature of the face are detected by an artificial neural network, respectively. The grayscale of the facial region may be used as a template feature, and generally, the central facial region merely including the eyes, the nose and the mouth is taken as the common facial template feature. Other features of the face after transform, such as Gabor features and local binary pattern (LBP) features, may be processed with multi-feature fusion.

5) Processing of Features (Dimension Reduction Processing)

High-dimensional facial features are mapped to low-dimensional features with better classification or recognition capability. For example, a common Principal Component Analysis (PCA)+Linear Discriminant Analysis (LDA) method may be employed. Then, the processed features are linked into a feature vector: v.

6) Calculation of the Distance Between Features of Two Images

For example, the cosine distance between the features of the two image (vectors: v₁ and v₂) is calculated as below:

$$d ( {v}_{1} , {v}_{2} ) = \frac{〈 {v}_{1} , {v}_{2} 〉}{‖ {v}_{1} ‖ \times ‖ {v}_{2} ‖ .}$$

Alternatively, the Euclidean distance between the features of the two images is calculated as below:

d(v₁,v₂)=∥v₁−v₂∥².

The level of the matching degree of the features of the two images is determined according to the distance between the features of the two images. The smaller the distance between the features of two images, the higher the level of the matching degree. The greater the distance between the features of the two images, the lower level of the matching degree.

Preferably, in the step S101, the user device 1 generates the image information of the social object expected by the user according to the image editing operation on a reference image by the user.

In this embodiment, the user may perform the image editing operation based on the reference image to obtain the image information of the social object expected by the user. For example, the reference image may include image information of a standard human face, an average face of all Chinese people, etc.

Preferably, the reference image is generated based on user-related information of the user.

For example, the user-related information of the user includes, but is not limited to, the image information of the user and other information of the user such as height, age, occupation, etc. In this embodiment, the reference image is generated based on the user-related information of the user, and therefore, the user can obtain the image information of the expected social object with relatively less image editing operations.

Here, the reference image may be generated by a specific application on the user device 1; or the reference image may be generated by the network device 2 at the cloud side of the specific application, and then the reference image is transmitted from the network device 2 to the user device 1. Preferably, the image editing operation includes at least one of the following operations: copying and pasting the physical characteristic modules; replacing the physical characteristic modules; adjusting the physical characteristic modules by dragging operation; and setting the physical characteristic modules by inputting parameters.

For example, the physical characteristic modules include an eye module, a nose module, and a mouth module, etc., and the image information of the social object expected by the user may be obtained by splicing the physical characteristic modules. The adjusting of the physical characteristic modules by dragging operation may include: adjusting the size, shape, position, and other features of the eyes, the nose, etc. Setting the physical characteristic modules by inputting parameters may include: setting the physical characteristic modules according to information including height, body fat ratio, and other features of the expected social object input by the user.

When the user is representing the image information of the expected social object, the image editing operation may be performed several times until the image information of the expected social object satisfying the user is obtained.

Preferably, the object information database stores user image information uploaded according to the predetermined image requirements.

In this embodiment, the user not only sends the image information of the expected social object to the network device 2, but also uploads the user image information of the user itself to the object information database of the network device 2. Therefore, plenty of user image information is stored in the object information database for match query. Specifically, the predetermined image requirements may include: limiting the processing and modification of the user image information, and limiting occlusion of the eyes, ears, etc.

Preferably, the image information includes text parameters and image parameters of the social object expected by the user. Specifically, in the step S212, the network device 2 performs the match query in the object information database according to the text parameters to obtain a plurality of candidate social objects matching with the text parameters. The network device 2 performs the match query in the plurality of candidate social objects according to the image parameters to obtain one or more social objects matching with the image parameters.

For example, the text parameters may include text description information (such as height, age, occupation, etc.) of the social object expected by the user. The image parameters may include image description information (such as facial features, fat, slim, etc.) of the social object expected by the user. In this embodiment, the match query in the object information database according to the text parameters is first performed to obtain a plurality of candidate social objects matching with the text parameters. Then, the match query in the plurality of candidate social objects according to the image parameters is perform to obtain one or more social objects matching with the image parameters from the plurality of candidate social objects. Here, the match query according to the text parameters is first performed to rule out the objects not matching with the text parameters in the object information database, and then the match query according to the image parameters is performed, thereby improving the efficiency of the match query and reducing the workload of the system.

Preferably, contact information of the presented social objects is in a hidden state. Specifically, the method further includes: acquiring, by the user device 1, a contact information request of a target social object in the presented social objects submitted by the user; and after the contact information request passes a verification, the contact information of the target social object is presented.

For example, after the user device 1 receives one or more social objects matching with the image information of the social object expected by the user sent by the network device 2, the contact information (such as a phone number, an email address, a home address, etc.) of the social objects is not presented to the user, namely, the contact information of the social objects is in the hidden state. If the user is interested in the image information of the target social object in the one or more social objects, the user may submit the contact information request for the target social object to obtain the contact information of the target social object.

Specifically, the verification of the contact information request includes, but is not limited to: whether the user satisfies a predetermined membership level, whether the user successfully pays for the contact information request, etc. Here, the verification of the contact information request may be completed by a specific application on the user device 1. Alternatively, the user device 1 may send the contact information request to the network device 2 at the cloud side of the specific application, and the verification of the contact information request is completed by the network device 2.

Preferably, the method further includes: sending, by the user device 1, the contact information request to the network device 2; receiving, by the network device 2, the contact information request about the target social object in the at least one social object sent by the user device 1; verifying, by the network device 2, the contact information request; sending, by the network device 2, the contact information of the target social object to the user device 1 when the contact information request passes the verification; receiving, by the user device 1, the contact information of the target social object sent by the network device 2 after the contact information request passes the verification; and presenting, by the user device 1, the contact information of the target social object.

In this embodiment, the user device 1 sends the contact information request to the network device 2 at the cloud side of the specific application, and the verification of the contact information request is completed by the network device 2. When the contact information request passes the verification, the network device 2 sends the contact information of the target social object to the user device 1.

Preferably, in the step S103, the user device 1 receives the one or more social objects matching with the image information and the contact information of each social object sent by the network device. The user device 1 presents the contact information stored in the user device by the target social object stored when the contact information request passes the verification.

In this embodiment, while the user device 1 receives the one or more social objects matching with the image information of the social object expected by the user sent by the network device 2, the contact information of each social object is also received by the user device 1, while the contact information of the social objects is not presented to the user. When the contact information request passes the verification, the contact information of the target social object stored in the user device 1 is presented to the user.

Preferably, the method further includes: adjusting, by the user device 1, the image information according to feedback information given by the user based on the presented social object; sending, by the user device 1, the adjusted image information to the corresponding network device 2; receiving, by the user device 1, one or more social objects matching with the adjusted image information sent by the network device 2; and presenting, by the user device 1, at least one of the one or more social objects.

For example, if the user is not satisfied with the one or more social objects sent by the network device 2, feedback information (e.g., small eyes, too old, etc.) about the one or more social objects may be given. The specific application on the user device 1 adjusts the image information of the social object expected by the user according to the feedback information, and then sends the adjusted image information to the corresponding network device 2. The network device 2 performs the match query again in the object information database according to the adjusted image information, and sends one or more social objects matching with the adjusted image information to the user device 1. Then, at least one of the one or more social objects is presented to the user by the specific application on the user device 1.

In another aspect of the present application, a method for providing social objects is provided, wherein the method includes the following steps:

generating, by a user device, image information of a social object expected by a user according to an image editing operation of the user;

sending, by the user device, the image information to a corresponding network device;

receiving, by the network device, the image information of the social object expected by the user sent by the user device;

performing, by the network device, a match query in an object information database according to the image information to obtain one or more social objects matching with the image information;

sending, by the network device, at least one of the one or more social objects to the user device;

receiving, by the user device, one or more social objects matching with the image information sent by the network device; and

presenting, by the user device, at least one of the one or more social objects.

In yet another aspect of the present application, a computer readable medium containing instructions is provided, and the instructions, when being executed, cause the system to perform the following steps:

generating image information of a social object expected by a user according to an image editing operation of the user;

sending the image information to a corresponding network device;

receiving one or more social objects matching with the image information sent by the network device; and

presenting at least one of the one or more social objects.

In yet another aspect of the present application, a computer readable medium containing instructions is provided, and the instructions, when being executed, cause the system to perform the following steps:

receiving image information of a social object expected by a user sent by a user device;

performing a match query in an object information database according to the image information to obtain one or more social objects matching with the image information; and

sending at least one of the one or more social objects back to the user device.

In yet another aspect of the present application, a user device for providing social objects is provided, which includes:

a processor; and

a memory configured to store computer executable instructions, wherein, the executable instructions, when being executed, cause the processor to perform the following steps:

generating image information of a social object expected by a user according to an image editing operation of the user;

sending the image information to a corresponding network device;

receiving one or more social objects matching with the image information sent by the network device; and

presenting at least one of the one or more social objects.

In yet another aspect of the present application, a network device for providing social objects is provided, which includes:

a processor; and

a memory configured to store computer executable instructions, wherein, the executable instructions, when being executed, cause the processor to perform the following steps:

receiving image information of a social object expected by a user sent by a user device;

performing a match query in an object information database according to the image information to obtain one or more social objects matching with the image information; and

sending at least one of the one or more social objects to the user device.

Compared with the prior art, in the present application, the user device generates the image information of the social object expected by the user according to the image editing operation of the user, and then sends the image information to the corresponding network device. The network device performs the match query in an object information database to obtain one or more social objects matching with the image information. Then, the network device sends at least one of the one or more social objects to the user device, and the at least one of the one or more social objects is presented to the user. Therefore, the user may quickly find the social objects matching with the image information of the social object expected by the user, improving the user experience. Further, the user may perform the image editing operation based on a reference image, which reduces the time of the image editing operation and improves the efficiency of the electronic/computer and network system. Furthermore, the network device may first perform the match query according to text parameters to rule out the objects in the object information base that does not match with the text parameters, and then perform the match query according to the image parameters, thereby improving the efficiency of the match query and reducing the workload of the system.

It should be noted that the present application can be implemented by software and/or a combination of software and hardware. For example, the present application can be realized by an application specific integrated circuit (ASIC), a general purpose computer, or any other similar hardware device. In one embodiment, the software program of the present application can be executed by a processor to implement the steps or functions described above. Similarly, the software programs (including related data structures) of the present application may be stored in a computer readable recording medium, such as a RAM memory, a magnetic or optical driver, a floppy disk, or other similar devices. In addition, some of the steps or functions of the present application may be implemented by hardware. For example, a circuit that is matched with a processor to perform all of the steps or functions.

In addition, a part of the present application can be applied as a computer program product. For example, computer program instructions, when the computer program instructions are executed by a computer, the method and/or technical solution according to the present application can be invoked or provided via computer operations. Those skilled in the art should be able to understand that the computer program instructions stored in a computer readable medium may be in the forms including, but not limited to, a source file, an executable file, an installation package, etc. Accordingly, the computer program instructions may be executed by the computer in the ways including, but not limited to, the instructions being directly executed by the computer, the instructions being compiled by the computer and then the compiled program being executed by the computer, the instructions being read or executed by the computer, or the instructions being read and installed by the computer and then the installed program being executed by the computer. Here, the computer readable medium may be any available computer readable storage medium or communication medium that is accessible to the computer.

The communication medium includes a medium through which a communication signal such as a computer readable instruction, a data structure, a program module or other data are transmitted from one system to another system. The communication medium may include conductive transmission medium (such as cables and wires (e.g., optic fiber, coaxial cables, etc.)) and wireless (non-conductive transmission) medium capable of propagating energy waves, such as sound, electromagnetic, radio frequency (RF), microwave and infrared. The computer readable instructions, data structures, program modules or other data may be embodied. For example, as modulated data signals in a wireless medium (e.g., a carrier wave or a similar mechanism that can represent the computer readable instructions, data structures, program modules or other data as a part of the spread spectrum technique). The term “modulated data signal” refers to a signal with one or more features being changed or set in a manner of information encoding in the signal. The modulation may be analog, digital or hybrid modulation technique. Communication medium (particularly carrier waves and other propagating signals containing data that can be used by the computer system) may not be a computer readable storage medium.

As an example rather than limitation, the computer readable storage medium may include volatile and non-volatile, removable and non-removable medium implemented in any method or technique for storing information such as computer readable instructions, data structures, program modules or other data. For example, the computer readable storage medium includes, but is not limited to, a volatile memory such as random access memories (RAM, DRAM, SRAM); a non-volatile memory such as a flash memory, various read only memories (ROM, PROM, EPROM, EEPROM), magnetic and ferromagnetic/ferroelectric memories (MRAM, FeRAM); a magnetic and optical storage device (hard disk, magnetic tape, CDs, DVDs); or other currently known mediums or mediums that may be developed in the future capable of storing computer readable information/data for a computer system to use. The “computer readable storage medium” is not composed of carrier waves or propagated signals.

It is obvious to those skilled in the art that the present application is not limited to the details of the above exemplary embodiments, and the present invention can be implemented in other specific forms without departing from the spirit or essential features of the present application. Therefore, the embodiments should be considered as exemplary and non-restrictive illustrations, from any point of view. The scope of the present application is defined by the appended claims rather than the above description, and aims to include all changes falling within the meaning and scope of the equivalent elements of the claims in the present application. Any reference numeral in the claims should not be regarded as limiting the claims involved. In addition, it is clear that the term “comprise” does not exclude other units or steps, and singular does not exclude plural. The words of first, second, and so on are used to denote names of elements and are not intended to imply any particular order.

What is claimed is:

1. A method for providing social objects at a user device side, comprising:
generating image information of a social object expected by a user according to an image editing operation of the user;
sending the image information to a corresponding network device;
receiving one or more social objects matching with the image information sent by the network device; and
presenting at least one of the one or more social objects.

2. The method according to claim 1, wherein, the step of generating the image information of the social object expected by the user according to the image editing operation of the user, comprises:
generating the image information of the social object expected by the user according to the image editing operation on a reference image by the user.

3. The method according to claim 2, wherein, the reference image is generated based on user related information of the user.

4. The method according to claim 1, wherein, the image editing operation comprises at least one of the following steps:
copying and pasting physical characteristic modules;
replacing the physical characteristic modules;
adjusting the physical characteristic modules by a dragging operation;
setting the physical characteristic modules according to input parameters.

5. The method according to claim 1, wherein, contact information of the presented social objects is at a hidden state;
wherein, the method further comprises:
acquiring a contact information request of a target social object in the presented social objects submitted by the user; and
presenting the contact information of the target social object after the contact information request passes a verification.

6. The method according to claim 5, wherein, the step of presenting the contact information of the target social object after the contact information request passes a verification, comprises:
sending the contact information request to the network device;
receiving the contact information of the target social object sent by the network device after the contact information request passes the verification; and
presenting the contact information of the target social object.

7. The method according to claim 5, wherein, the step of receiving the one or more social objects matching with the image information sent by the network device, comprises:
receiving the one or more social objects matching with the image information and the contact information of each of the one or more social objects sent by the network device;
wherein, after the contact information request is verified, presenting the contact information of the target social object, comprises:
after the contact information request passes the verification, presenting the contact information of the target social object stored in the user device.

8. The method according to claim 1, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.

9. A method for providing social objects at a network device side, comprising:
receiving image information of a social object expected by a user sent by a user device;
performing a match query in an object information database according to the image information to obtain one or more social objects matching with the image information; and
sending at least one of the one or more social objects back to the user device.

10. The method according to claim 9, wherein, the object information database stores user image information uploaded according to a predetermined image requirement.

11. The method according to claim 9, wherein, the image information comprises text parameters and image parameters of the social object expected by the user;
wherein, the step of performing the match query in the object information database according to the image information to obtain one or more social objects matching with the image information, comprises:
performing the match query in the object information database according to the text parameters to obtain a plurality of candidate social objects matching with the text parameters; and
performing the match query in the plurality of candidate social objects according to the image parameters to obtain one or more social objects matching with the image parameters.

12. The method according to claim 9, further comprising:
receiving a contact information request of a target social object in the at least one of the one or more social objects sent by the user device;
verifying the contact information request; and
sending the contact information of the target social object to the user device after the contact information request passes the verification.

13. A method for providing social objects, comprising:
generating, by a user device, image information of a social object expected by a user according to an image editing operation of the user;
sending, by the user device, the image information to a corresponding network device;
receiving, by the network device, the image information of the social object expected by the user sent by the user device;
performing, by the network device, a match query in an object information database according to the image information to obtain one or more social objects matching with the image information;
sending, by the network device, at least one of the one or more social objects to the user device;
receiving, by the user device, one or more social objects matching with the image information sent by the network device; and
presenting, by the user device, at least one of the one or more social objects received by the user device.

14. The method according to claim 2, wherein, the image editing operation comprises at least one of the following steps:
copying and pasting physical characteristic modules;
replacing the physical characteristic modules;
adjusting the physical characteristic modules by a dragging operation;
setting the physical characteristic modules according to input parameters.

15. The method according to claim 3, wherein, the image editing operation comprises at least one of the following steps:
copying and pasting physical characteristic modules;
replacing the physical characteristic modules;
adjusting the physical characteristic modules by a dragging operation;
setting the physical characteristic modules according to input parameters.

16. The method according to claim 2, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.

17. The method according to claim 3, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.

18. The method according to claim 4, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.

19. The method according to claim 5, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.

20. The method according to claim 6, further comprising:
adjusting the image information according to feedback information given by the user based on the presented social objects;
sending the adjusted image information to the corresponding network device;
receiving one or more social objects matching with the adjusted image information sent by the network device; and
presenting at least one of the one or more social objects.
